(19) United States
(12) Patent Application Publication
(10) Pub. No.: US 2006/0084495 A1
(43) Pub. Date: Apr. 20, 2006

(54) Wagering game with feature for recording records and statistics

(75) Inventors: Joel R. Jaffe, Glenview, IL (US); Allon G. Englman, Chicago, IL (US)

Correspondence Address: JENKENS & GILCHRIST, P.C., 225 WEST WASHINGTON, SUITE 2600, CHICAGO, IL, 60606, US

(73) Assignee: WMS Gaming Inc.

(21) Appl. No.: 11/244,967

(22) Filed: Oct. 6, 2005

Related U.S. Application Data
(60) Provisional application No. 60/619,690, filed on Oct. 19, 2004.

(51) Int. Cl. A63F 13/00

(52) U.S. Cl. 463/20; 463/27

(57) ABSTRACT

A method for playing a wagering game includes receiving wager inputs from a player for a wagering game. At least one randomly-selected outcome is selected from a plurality of outcomes in response to receiving the wager inputs. A gaming record is obtained based on a gaming event during a first gaming session of the wagering game. A data set representing the gaming record is stored during the first gaming session. During a second gaming session of the wagering game, the gaming record is displayed as defined by the data set.

### RELATED APPLICATIONS

This application is related to and claims priority to U.S. Provisional Patent Application Ser. No. 60/619,690 filed Oct. 18, 2004, titled “Wagering Game With Feature For Recording Records And Statistics,” which is incorporated herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming terminals for playing a wagering game and, more particularly, to a gaming terminal having a feature for keeping records and statistics across gaming sessions.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is the use of a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

In current basic games, bonus games, and progressive games, the player is provided with little incentive to return the game at a later time. Once the player chooses to stop playing the game in that round, the player is immediately awarded any credits that are remaining and also loses assets that have been accumulated, but not yet awarded. For example, in some games, the bonus game consists of the player collecting assets and when a certain number or combination of assets is accumulated, the player wins an award. However, should the player choose to leave the game prior to winning the award, the player loses all of the assets accumulated. This can cause player frustration and does not provide the player with any incentive to return to the game.

Such a system also encourages “vulturing,” in which the “vulturing” player waits for a person who is close to winning an award to leave the gaming machine prior to the winning of the award. The “vulturing” player then begins to play the machine, and may quickly win the award without investing much time into the game. This is also frustrating for other players.

Thus, there is a need to allow a player to accumulate assets on gaming terminals and to have those assets restored to them should the player return to the game at a later time. This way, should a player choose to leave a game, anything the player has accumulated during the game goes with them and is restored at a later time when the player returns to the game. This alleviates the player frustration at losing assets that they have accumulated and also provides the player an incentive to return to the game at a later date.

Another need is directed to reporting records and/or statistics based on previous wagering sessions of the player. Reporting information, such as a player's records, provides the player with a sense of achievement and progress in a particular wagering game. A further need is directed to awarding the player an award when a gaming record has been exceeded. Providing a solution to these needs would enhance the player's gaming experience and would provide additional incentives for the player to return to the game at a later date.

### SUMMARY OF THE INVENTION

A method for playing a wagering game includes receiving wager inputs from a player for a wagering game. At least one randomly-selected outcome is selected from a plurality of outcomes in response to receiving the wager inputs. A gaming record is obtained based on a gaming event during a first gaming session of the wagering game. A data set representing the gaming record is stored during the first gaming session. During a second gaming session of the wagering game, the gaming record is displayed as defined by the data set.

In another aspect of the present invention, a gaming system for playing a wagering game includes a display and a controller coupled to the display. The display displays at least one randomly-selected outcome of a plurality of outcomes in response to accepting wager inputs from a player. The controller is programmed to identify a gaming record based on the randomly-selected outcome during a first gaming session of the wagering game. A data set representing the gaming record is stored. During a second gaming session of the wagering game, the gaming record is displayed as defined by the data set.

In an alternative aspect of the present invention, a method for conducting a wagering game includes receiving wager inputs from a player for a wagering game. The wagering game is being played by the player during a gaming session. At least one randomly-selected outcome is selected from a plurality of outcomes in response to receiving the wager inputs, wherein the plurality of outcomes includes a record-making outcome. In response to achieving the record-making outcome, a data set representing the record-making outcome is saved before discontinuing the gaming session. The data set is accessed in a subsequent gaming session. The data set is changed to represent a new record-making outcome, which is triggered during the subsequent gaming session.

In an alternative aspect of the present invention, a method for conducting a wagering game includes receiving wager inputs from a player for a wagering game. The wagering game is being played by the player during a gaming session. At least one randomly-selected outcome is selected from a plurality of outcomes in response to receiving the wager inputs, wherein the plurality of outcomes includes a record-making outcome. A player that is playing the wagering game is identified and, in response to achieving the record-making outcome, a data set representing the record-making outcome is stored at a storage location associated with the player. Information related to the record-making outcome is displayed in a subsequent gaming session.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE FIGURES

FIG. 1 is a perspective view of a video gaming terminal according to one embodiment of the present invention.

FIG. 2 is a block diagram of the gaming terminal of FIG. 1.

FIG. 3A is a representation of a records screen showing sequential wins for gaming events during a first gaming session, according to another embodiment of the present invention.

FIG. 3B is the records screen of FIG. 3A during an eighth gaming session, according to an alternative embodiment of the present invention.

FIG. 4A is a representation of a display showing a records screen for a number of gaming terminals, according to an alternative embodiment of the present invention.

FIG. 4B is an enlarged view of the records screen of FIG. 4A.

FIG. 4C is a representation of the records screen of FIG. 4A showing top current players, according to an alternative embodiment of the present invention.

FIG. 5 is a representation of a records screen showing the top ten bonuses for a number of previous gaming sessions, according to an alternative embodiment of the present invention.

FIG. 6 is a representation of a bonus game showing a personal high score, according to an alternative embodiment of the present invention.

FIG. 7 is a representation of a records screen showing an all-time award, according to an alternative embodiment of the present invention.

FIG. 8 is a representation of a records screen showing all bonus areas completed, according to an alternative embodiment of the present invention.

FIG. 9 is a representation of a records screen notifying the changing of a gaming symbol to a wild symbol, according to an alternative embodiment of the present invention.

FIG. 10 is a representation of a records screen showing a record amount of wins, according to an alternative embodiment of the present invention.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

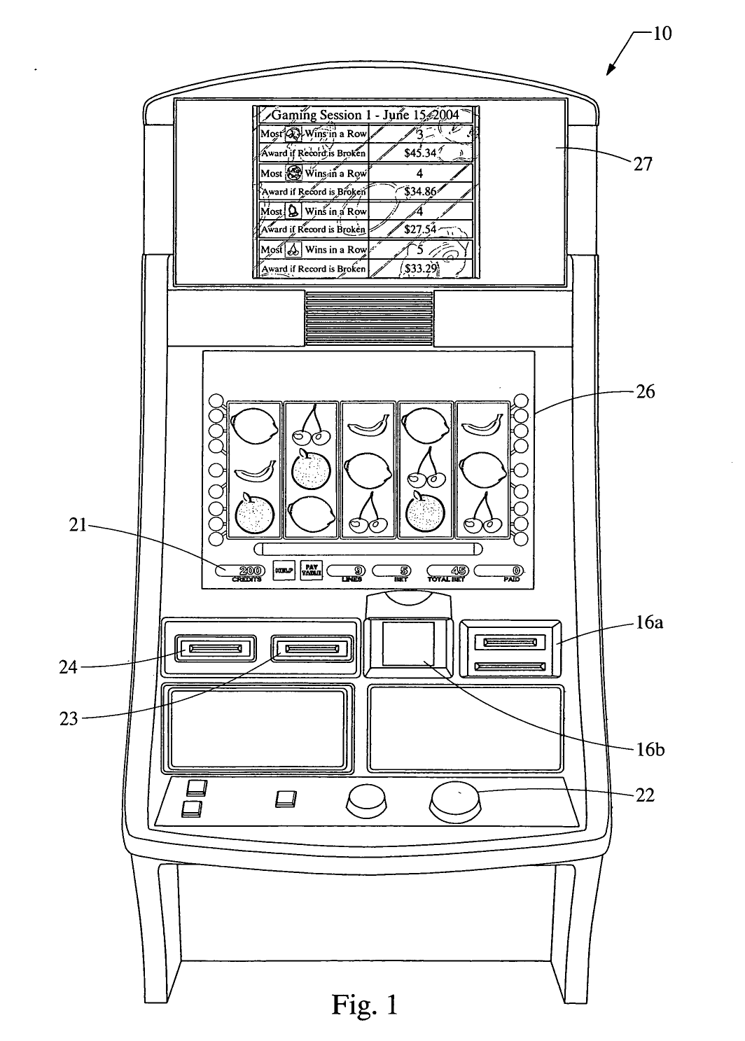

FIG. 1 shows a perspective view of a typical gaming terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play video slots or a video casino game, such as blackjack, slots, keno, poker, etc.

As shown, the gaming terminal 10 includes input devices, such as a wager acceptor 16 (shown as a card wager acceptor 16a and a cash wager accepter 16b), a touch screen 21, a push-button panel 22, and an information reader 24. For outputs, the gaming terminal 10 includes a payout mechanism 23, a main display 26 for displaying information about the basic wagering game, and a secondary display 27 that may display an electronic version of a pay table, and/or also possibly game-related information or other entertainment features. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The cash wager acceptor 16a may include a coin slot acceptor or a note acceptor to input value to the gaming terminal 10. The card wager acceptor 16b may include a card-reading device for reading a card that has a recorded monetary value with which it is associated. The card wager acceptor 16b may also receive a card that authorizes access to a central account, which can transfer money to the gaming terminal 10.

Also included is the payout mechanism 23, which performs the reverse functions of the wager acceptor. For example, the payout mechanism 23 may include a coin dispenser or a note dispenser to output value from gaming terminal 10. Also, the payout mechanism 23 may also be adapted to receive a card that authorizes the gaming terminal to transfer credits from the gaming terminal 10 to a central account.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The outcome of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes the touch screen 21 overlaying the entire monitor (or a portion thereof) to allow players to make game-related selections. Alternatively, the gaming terminal 10 may have a number of mechanical reels to display the game outcome, as well.

In some embodiments, the information reader 24 is a card reader that allows for identification of a player by reading a card with information indicating his or her true identity. Currently, identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the player-identification card reader 24, which allows the casino's computers to register that player's wagering at the gaming terminal 10. The information reader 24 may also include a keypad (not shown) for entering a personal identification number (PIN). The gaming terminal 10 may require that the player enter their PIN prior to obtaining information. The gaming terminal 10 may use the secondary display 27 for providing the player with information about his or her account or other player-specific information. Also, in some embodiments, the information reader 24 may be used to restore assets that the player achieved during a previous game session and had saved.

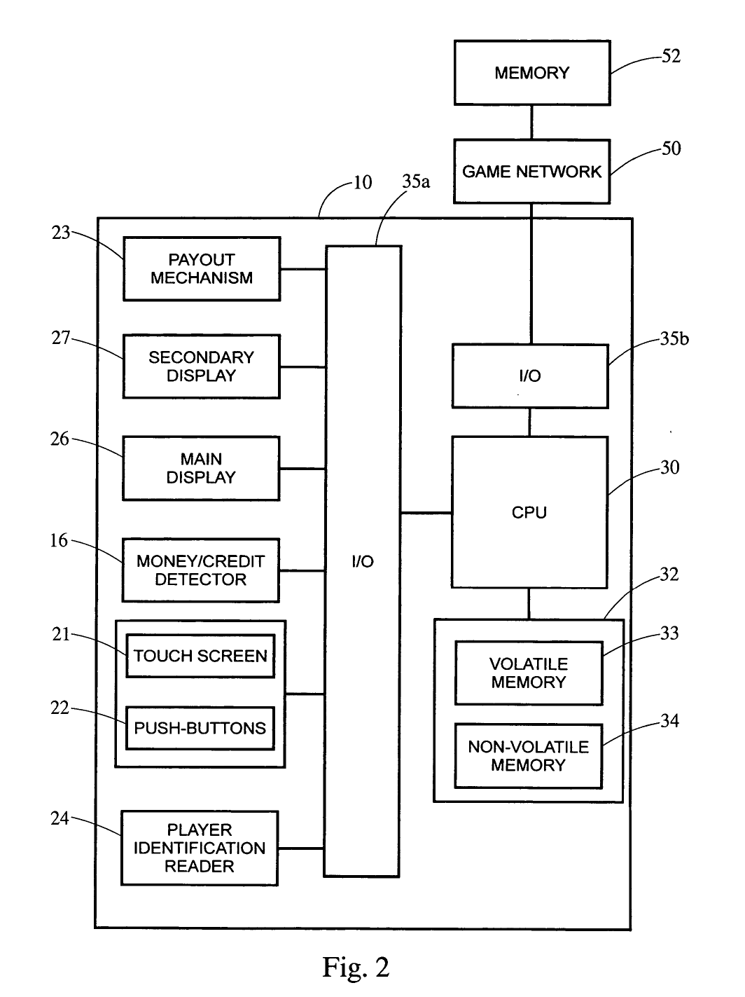

As shown in FIG. 2, the various components of the gaming terminal 10 are controlled by a central processing unit (CPU) 30 (such as a microprocessor or microcontroller). To provide the gaming functions, the CPU 30 executes a game program that allows for the randomly selected outcome. The CPU 30 is also coupled to or includes a local memory 32. The local memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the local memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

In some embodiments, the CPU 30 may not be inside the gaming terminal 10. Instead, the CPU 30 may be part of a game network 50 (FIG. 2) and may be used to control numerous gaming terminals 10. In these embodiments, the CPU 30 will run the basic games for each of the gaming terminals 10, and may also be used to link the gaming terminals 10 together. The game network 50 can include progressive jackpots that are contributed to by all or some of the gaming terminals 10 in the network (e.g., terminal-level jackpots that only each terminal 10 contributes to, bank-level jackpots that are contributed to by all of the terminals 10 in a particular bank, and wide-area jackpots that are contributed to by a larger number of terminals 10, such as multiple banks). Alternatively, the game network 50 can allow the player to retrieve assets obtained while playing one terminal 10 at a different gaming terminal that is also part of the game network. Assets may be any number of things, including, but not limited to, monetary or non-monetary awards, features that a player builds up in a bonus or progressive game to win awards, etc.

In some embodiments, the CPU 30 is also used with the information reader 24 to restore saved assets. For example, in one embodiment, the information reader 24 is adapted to receive and distribute tickets. The tickets each include a unique identifier. The unique identifier links the ticket to a file contained within the local memory 32 or a system memory 52 located in the game network 50. The file includes the assets that are being stored from a previous game. Monetary awards include game credits or money, while the non-monetary awards can be free plays (e.g., free spins), multipliers, or access to bonus and/or progressive games.

When a player inserts a ticket into the information reader 24, the CPU 30 obtains the unique identifier and causes the appropriate memory 32, 52 to be searched, and the file containing the unique identifier matching the identifier on the ticket is retrieved. Any assets or other information contained in this file are then transmitted to the gaming terminal 10, and the player regains any assets that were saved during a previous game. This allows the player to keep assets even after a particular gaming session ends, which increases player commitment to a game and decreases vulturing.

In other embodiments, the information reader 24 may include a card reader, and the unique identifier provided at the gaming terminal 10 may be stored on a personal identification card, such as one described above. Or, the gaming terminal 10 includes a radio frequency identification device (RFID) transceiver or receiver so that an RFID transponder held by the player can be used to provide the unique identifier of the player at the gaming terminal 10 without the need to insert a card into the gaming terminal 10. RFID components can be those available from Pacific Northwest National Laboratory (under the United States Department of Energy) of Richland, Wash.

In other embodiments, the information reader 24 may include a biometric reader, such as a finger, hand, or retina scanner, and the unique identifier may be the scanned biometric information. Additional information regarding biometric scanning, such as fingerprint scanning or hand geometry scanning, is available from International Biometric Group LLC of New York, N.Y. Other biometric identification techniques can be used as well for providing a unique identifier of the player. For example, a microphone can be used in a biometric identification device on the gaming terminal so that the player can be recognized using a voice recognition system.

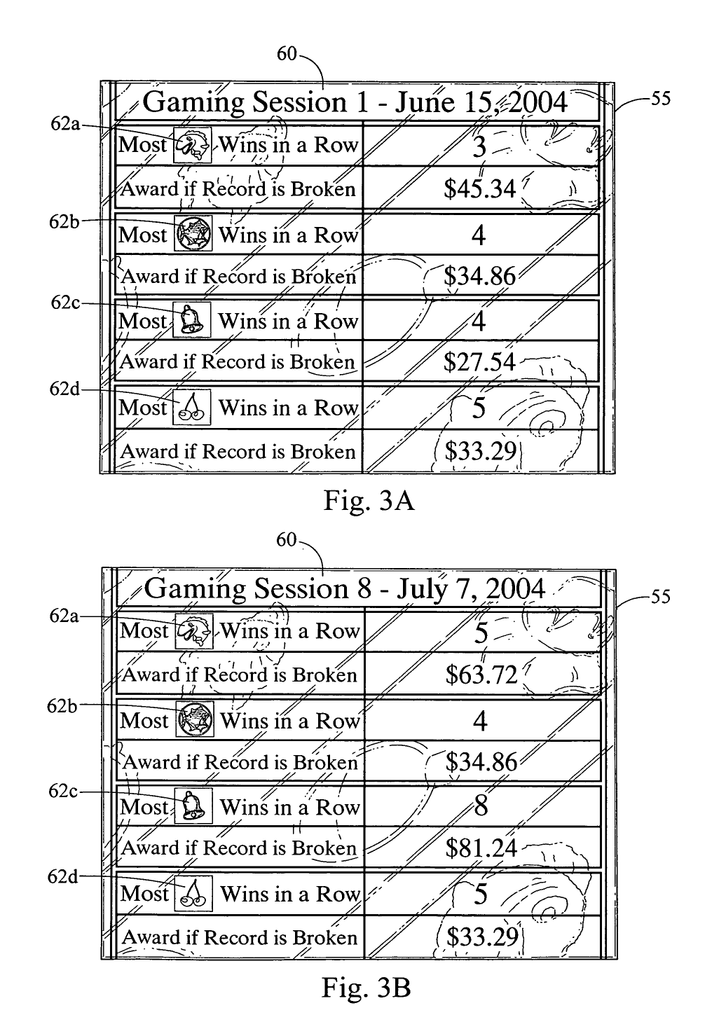

In summary, there are many techniques in which to provide a unique identifier for the player so that the assets accumulated by the player during one wagering session can be stored in either the system or local memory 52, 32, thereby allowing the player to subsequently access those assets at the same gaming terminal 10 or a different gaming terminal within the network 50. As described below with reference to FIGS. 3A to 10, various assets related to the wagering game features and formats can be stored after one gaming session and used in a subsequent gaming session(s) to enhance the gaming experience for the player.

Referring to FIGS. 3A-3B, a record screen 55 includes a message section 60 and a plurality of record symbols 62a-62d. The record screen 55 can be displayed in either one of the main display 26 and the secondary display 27. The message section 60 notifies the player of the current gaming session, e.g., “Gaming Session 1,” and the current date, e.g., “Jun. 15, 2004.” The record symbols 62a-62d are symbols corresponding to gaming symbols, which are generally displayed during a base game or a bonus game. For example, the gaming symbols can be symbols displayed in a plurality of spinning reels, wherein a win is generally awarded when two or more symbols of the same kind are aligned along an active payline.

The record screen 55 includes a plurality of rows and columns for notifying the player regarding current gaming records. The term gaming records refers to an achievement or accomplishment, as opposed to merely a file for recording information. As shown in FIG. 3A, in the first row the player is notified that most wins “in a row” of a fish symbol 62a is “3” wins. Thus if the record is exceeded, e.g., the player wins “4” wins in a row of the fish symbol 62a, then the player is awarded “$45.34.” Similarly, if the player achieves six or more wins in a row of a cherry symbol 62d, then the player receives “$33.29” for beating the current record. The award for breaking a previous record is in addition to the normal payout that would normally be awarded if the player won a winning combination.

When the player ends the current gaming session, the player's records are stored for use in a subsequent gaming sessions. Thus, in subsequent gaming sessions the player is required to achieve a greater number of wins to win an award for breaking a previous record. As the number of wins that is required increases, the award also increases.

Optionally, a manufacturer-specific storage device, such as a memory card, is used to record a player's winning information (e.g., all-time winnings) for games played on gaming machines manufactured by a specific manufacturer. In general, the memory card may be used only on gaming machines of a particular manufacturer. For example, the player may use the memory card to view transaction details for previous wagering sessions on any gaming machine of the particular manufacturer. In another example, the player may use the memory card to earn compensations (e.g., award points, bonus games, credits, etc.) that are specific to the particular manufacturer. The earned compensations may be presented, for example, in a catalogue of the manufacturer. The memory card may be used in all the games of a particular manufacturer (e.g., all games on gaming machines manufactured by WMS Gaming Inc.) or may be restricted to particular games of the particular manufacturer (e.g., progressive games on gaming machines manufactured by WMS Gaming Inc.).

As shown in FIG. 3B, in “Gaming Session 8” the player is required to achieve five wins in a row of the fish symbol 62a to break the previous record. If the player is successful, then the player receives an award of “63.72.” Increasing the required number of wins, as well as the award, provides a sense of achievement for the player and, consequently, a more pleasurable gaming experience. In contrast to winning the same award for each win, the player is provided with a goal: to continue breaking his or her previous records. The player has an incentive to come back to the same or a different gaming terminal with the same game to continue where he or she has left off in the previous gaming session. As such, the player's personal records are stored in a memory device (e.g., the memory 32 or the memory 52) for use in a subsequent gaming session.

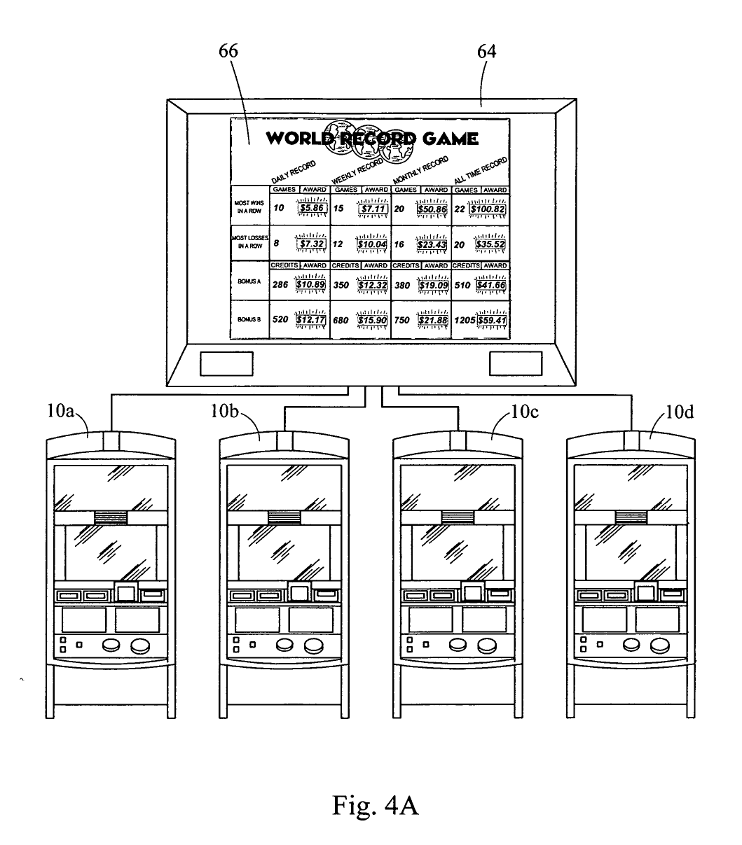

Referring to FIGS. 4A-4C, a record display 64, also referred to as a standalone display, is positioned in a central location above a plurality of gaming terminals 10a-10d, according to an alternative embodiment of the present invention. The record display 64 can be selected from a group including any one of the displays described above in reference to the main display 26. For example, the record display 64 is a plasma screen that is large enough for the players of the gaming terminals 10a-10d to easily notice any information displayed in the record display 64.

The record display 64 displays record information received from the gaming terminals 10a-10d. To receive awards for breaking a previous record, the players of the gaming terminals 10a-10d compete not only against themselves, but also against each other. When a player begins a new gaming session on one of the gaming terminals 10a-10d, the player's record status from previous gaming sessions is retrieved from a memory device and the player begins playing from the point where he or she has terminated game-play in a previous gaming session. Thus, if before concluding the previous gaming session the player was having a winning streak (e.g., the player has just won five consecutive wins in a row), the player's winning streak is continued in the current gaming session.

The record display 64 includes a record screen 66, in one embodiment, for showing various record information the players of the gaming terminals 10a-10d. The record screen 66 shows a “Daily Record,” a “Weekly Record,” a “Monthly Record,” and an “All-Time Record.” For each of the different category of records, the players can be awarded for “Most Wins In A Row,” for “Most Losses In A Row,” for breaking a “Bonus A” record, and for breaking a “Bonus B” record.

For example, a player that achieves eleven wins in a row for the current day will break the previous record of ten. As a reward, the player will receive $5.86. If the player had won seven wins in a row in the previous gaming session, and if the player wins four wins in a row when he or she starts playing in the current gaming session, then the player can break the current daily record of ten. Specifically, the player is able to link his previous wins to the current wins if the wins are sequential, even if the wins may be separated by a time period of months, which that may intervene between the previous and the current gaming session.

Similarly, a player can receive an award for obtaining the most losses in a row. For example, a player can receive $35.52 for losing twenty-one times in a row and becoming the “All Time Loser.” In another award group, the player can receive an award for obtaining the most credits during a specific bonus game. For example if the player receives 521 credits during the current day while playing a Bonus B game, then the player will receive and award of $12.17.

For the player to be able to link to previous wins in a previous gaming session, the player may be limited to a respective time period. For example, to qualify for a daily record the player may be able to use only wins that have been won during the current day (i.e., after 12:00 a.m.). Thus, if the player has won 1,000 credits while playing a Bonus B game over the previous two months, the player will not qualify for an award for the daily, weekly, and monthly records. However, the player can still qualify for the all time record, wherein the player only needs 206 additional credits to break the current all time record of 1205 credits.

Optionally, at least a portion of the wager inputs received from any one of the players of gaming terminals 10a-10d can be used to find a progressive jackpot. Information regarding the progressive jackpot can be displayed on the record display 64.

In an alternative embodiment, shown in FIG. 4C, a record screen 166 includes columns showing the names and record of current players. For example, for the daily record the top current player is Joel, having won eight wins in a row, three losses in a row, 325 credits in the Bonus A game, and 450 credits in the Bonus B game. From the four different groups of records, Joel is the record holder for only one—the Bonus A game. For example, while the daily record for the most wins in a row is ten, Joel has only eight wins in a row Joel. This means that the daily record player is currently not playing. For Bonus A, Joel is the top and current player, wherein the daily record of 325 credits matches the 325 credits won by Joel. Optionally, if there is a separate top current player for each one of the award groups, then more than one name is displayed in the top current player column.

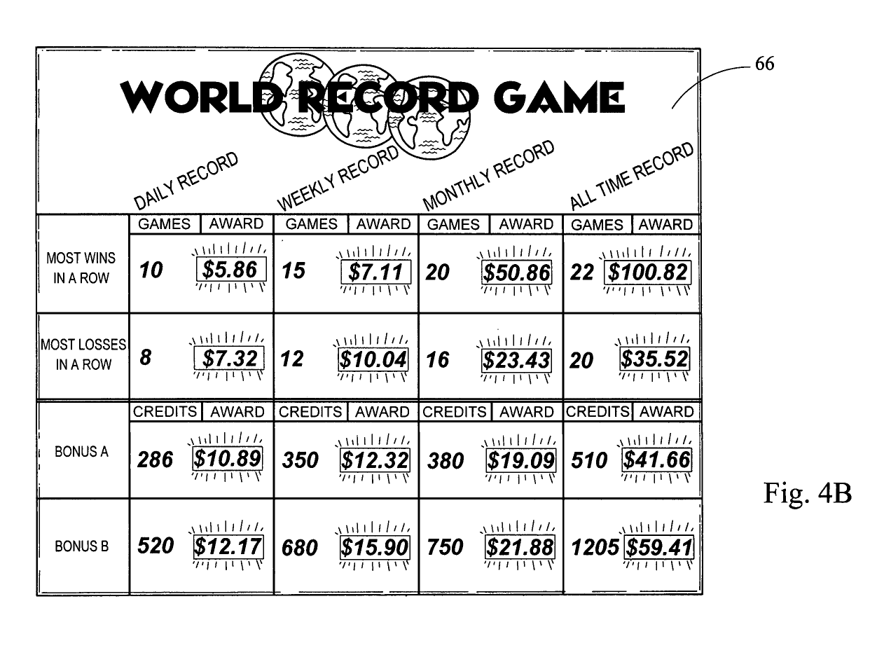

Referring to FIG. 5, a record screen 155 shows a “Hall Of Champions” table that includes information regarding the top players for a particular game or games. The top player is determined according to the number of credits that the players has won over a plurality of gaming sessions. For example, the top player that is shown is Bill W. with a total of 1,786 credits that have been won during three gaming sessions.

In the displayed embodiment, the top ten players are listed. Alternatively, more or less players can be listed, and additional or less information can be displayed. For example, the average won credits can be shown in a separate column. Optionally, the determination of the top player can be made according to other criteria, such as the most credits won per gaming session.

The record screen 155 can be displayed on the main display 26 or on the secondary display 27. The record screen 155 can be displayed at all times during the gaming session, or only at the request of the player. For example, the player can press a button to view the current “Hall Of Champions.” Alternatively, the record screen 155 can be automatically displayed when a change has occurred in the current records.

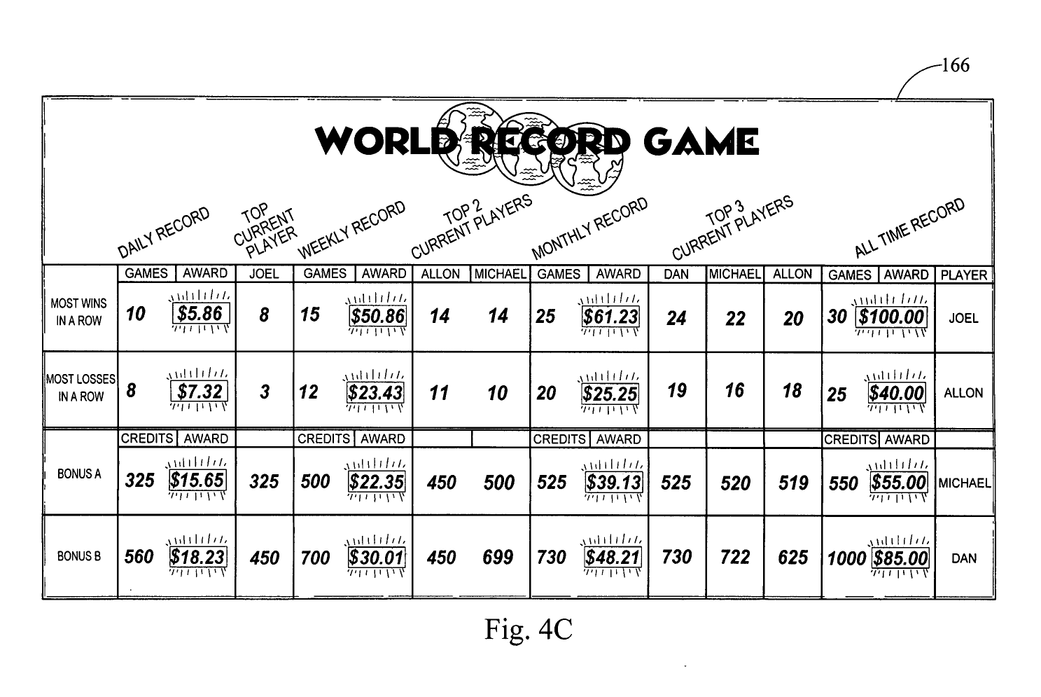

Referring to FIG. 6, a main display 126 includes a message 70 and a “Jackpot Party Bonus” game screen. To play the “Jackpot Party Bonus,” the player selects one or more bonus chests 72, to reveal hidden credit awards, until a “Pooper” symbol is revealed. If the player reaches a new personal high score, the player is notified with the message 70 that he or she has reached a new high score. The player's high score is stored when the player terminates a gaming session, and is updated during subsequent gaming sessions.

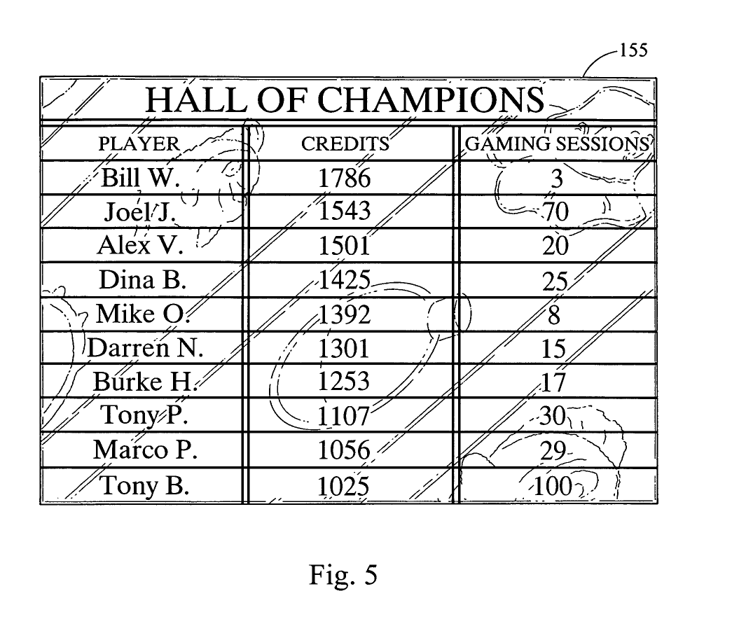

Referring to FIG. 7, a record screen 255 includes a message for indicating to a player that a new player record has been achieved. Specifically, the player has reached a score that qualifies for entry in the “All time Top 10” records of a “Jackpot Party Bonus” game. In return, the player receives an award of 500 credits.

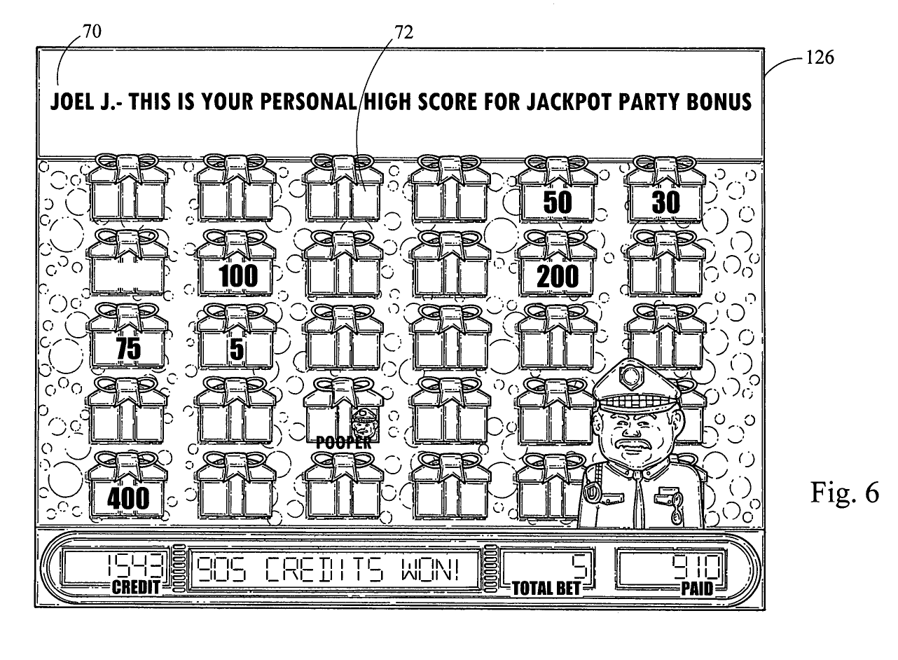

Referring to FIG. 8, a record screen 355 includes a message for indicating to a player that a game feature has been completed by a plurality of players. Specifically, the player is notified that several players have completed “All Bonus Areas.” The record screen 355 provides the players with a sense of satisfaction and achievement, and, optionally, with a credits award.

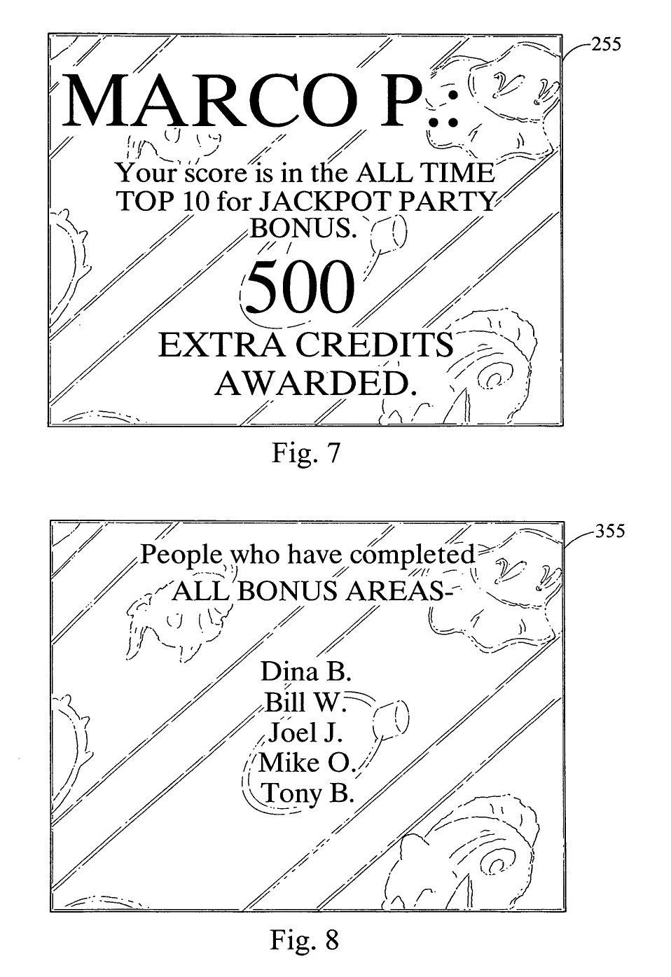

Referring to FIG. 9, a record screen 455 includes a message for indicating to a player that a record has been broken and that a new game feature is now available. For example, the player has achieved “20 Wins In A Row” during a base game or a bonus game. In return, a fish symbol 74 is now treated as a “Wild” symbol during subsequent games, during the current gaming session, or during subsequent gaming sessions. Thus, the player's likelihood of winning have been improved by adding the extra “Wild symbol, which can be substituted for any game symbol to obtain a winning combination. Optionally, the fish symbol 74 can be treated as any other advantageous symbol.

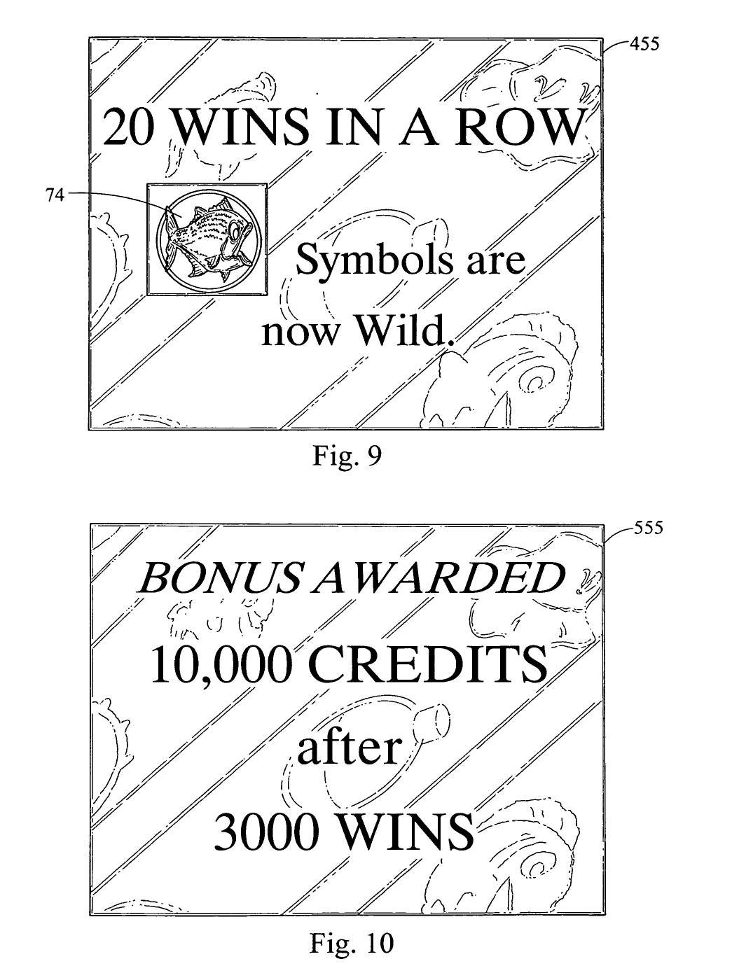

Referring to FIG. 10, a record screen 555 includes a message for indicating to a player that a bonus worth “10,000 Credits” has been awarded after “3,000 Wins.” Optionally, the message can be displayed as an incentive to the player prior to the player reaching 3,000 wins.

The prizes awarded as described above in reference to FIGS. 3A-10 can be funded in various ways. For example, a single pool can fund all the awards, wherein the pool receives a small portion of every wager. The pool can be funded by wagers received from a single gaming terminal or from a plurality of gaming terminals. Alternatively, each award can have its own funding, or pool, based on a percentage of each wager input.

In another embodiment of the present invention, the player can elect not to be part of the “record” aspect of the invention, when playing a wagering game in accordance to any of the gaming methods described above in reference to FIGS. 1-10. Optionally, the player can elect to have a nickname displayed, to protect the player's privacy.

Alternatively, a player of a gaming terminal conducting a wagering game, in accordance with any of the above-described embodiments, has the option to make an additional wager before a time limit expires if a record of a current wagering session has not been exceeded. For example, if the player has not exceeded a current record, the player can insert more money within a predetermined time limit into the gaming terminal to attempt breaking a previous record. The time limit can be any predetermined time period, e.g., fifteen seconds. Thus, the player has the opportunity to attempt breaking a previous record without having to start a new wagering session.

In alternative embodiments, a player can use a telephone to access and use one or more of the player's accumulated game assets. For example, using a mobile phone, the player can dial a toll-free phone number to access his or her game assets. A central server associated with the network 50 (FIG. 2) can recognize the player's mobile number for identification purposes, via a caller-id feature, or, alternatively, the central server may require the player to create a unique code number (if, for example, the player uses a caller-id block feature). Optionally, the player may be required to enter an additional code for identifying a specific gaming machine 10.

Thus, the player can use his or her mobile phone to remotely access the wagering game and utilize the accumulated assets at a time and place according to the player's desire. For example, the player can restart a gaming session via the mobile phone at a point where he or she had previously stopped the session, or the player can choose, via the mobile phone, to play an accumulated bonus game that he or she had previously won, but not played.

In another example, the player can put money into a gaming machine 10 while the player is physically at the gaming machine 10. Before the player walks away from the gaming machine 10, the player can register the gaming machine 10 to the player's phone. The player can also let the gaming machine 10 know what assets it may intend to use in the future via remote access by the phone. For example, the player can register the phone number as a password required to access the player's assets on the gaming machine 10. The player can initiate an auto-play feature while at the gaming machine 10 or remotely via the phone. The auto-play feature of the gaming machine 10 is configured to report, e.g., via still or moving images on the phone, one or more of the gaming outcomes. Then, at a later time, the player returns to the gaming machine 10, re-checks into the gaming machine via the phone and, optionally, cashes out any winnings. While no actual gameplay occurs on the phone, the phone is used for accessing the player's assets and gaming outcomes on the gaming machine 10.

Optionally, the wagering game provides the player with access to accumulated assets and/or certain awards only if the player achieves a “Remote Play Winning Outcome.” If the player achieves this outcome (e.g., in a basic or bonus game), then he or she is allowed remote access to one or more of the accumulated assets and/or certain awards. For example, if the player achieves the “Remote Play Winning Outcome,” the player can have the option to select a smaller award while the player is physically present at the gaming machine 10 or a larger award if the player uses the telephone. In another example, the player may be given the option to play for smaller awards while the player is physically present at the gaming machine 10 or for larger awards if the player uses the telephone for gameplay initiation.

Alternative to using a voice telephone call to initiate a game or to access assets and/or awards, as described above, the player can send a text message. For example, the player can send a special code in the text message to log-in using a special number on the gaming machine 10.

For identification purposes, various verification ways can be used. For example, the player can enter the mobile telephone number into the gaming machine 10 as a player identification number. When the phone is near, the gaming machine 10 can detect it and verify the player identification number, e.g., the mobile number. For example, a receiver can be installed in the gaming machine 10 for detecting a mobile identifier (which may include the mobile number) that is periodically transmitted by mobile phones to the nearest mobile base station. Thus, the gaming machine 10 would have similar capabilities to the mobile base station.

Alternatively, the gaming machine 10 can send a voice or text message to the mobile telephone to verify the player's identification number. For example, the gaming machine 10 can send a text message asking the player to reply to the text message using a predetermined code for confirmation purposes. Optionally, a Bluetooth identifier can be used for logging-in and/or verification purposes, wherein the Bluetooth identifier is unique per phone and/or service carrier.

Special benefits can be offered to a player based on the telephone brand and/or service carrier. For example, predetermined assets can be made available to the player only if they use a telephone of brand X that uses service carrier Y. Optionally, the special benefits can be made available based on the telephone model.

While the invention is susceptible to various modifications and alternative forms, specific embodiments thereof have been shown by way of example in the drawings and herein described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

What is claimed is:

1. A method for playing a wagering game, comprising:
receiving wager inputs from a player for a wagering game;
selecting at least one randomly-selected outcome of a plurality of outcomes in response to said receiving step;
obtaining a gaming record based on a gaming event during a first gaming session of said wagering game;
storing a data set representing said gaming record; and
during a second gaming session of said wagering game, displaying said gaming record as defined by said data set.

2. The method of claim 1, further comprising selecting said gaming event from a group including sequential wins, sequential losses, and a bonus winning amount.

3. The method of claim 1, further comprising awarding a bonus award if said gaming record is exceeded by a new gaming record.

4. The method of claim 1, further comprising awarding a progressive jackpot in response to said obtaining step, said progressive jackpot being funded at least in part by a percentage of previous wager inputs of said player.

5. The method of claim 1, further comprising awarding a bonus award in response to said gaming record being one of a group including a daily record, a weekly record, a monthly record, and an all-time record.

6. The method of claim 5, wherein said bonus award is awarded in addition to a game award that is awarded when said randomly-selected outcome is a winning game outcome.

7. The method of claim 1, further comprising obtaining additional gaming records based on at least one of said gaming event and additional gaming events.

8. The method of claim 7, further comprising displaying said additional gaming records for a number of top players of said wagering game.

9. The method of claim 8, wherein said displaying includes showing said additional gaming records on a display, said display including at least one of a main display of a gaming terminal, a secondary display of said gaming terminal, and a standalone display.

10. The method of claim 1, further comprising displaying a number of top bonuses based on a plurality of previous gaming sessions.

11. The method of claim 1, wherein said displaying of said gaming record includes displaying the top ten player names, based on a predetermined number of previous gaming sessions, and the corresponding credit amount for each one of said players.

12. The method of claim 1, wherein said displaying of said gaming record includes displaying a personal high score for said wagering game.

13. The method of claim 1, further comprising awarding an extra award when said gaming record is an all-time top award for a bonus game.

14. The method of claim 13, wherein said extra award is awarded in addition to a game award that is awarded when said randomly-selected outcome is a winning game outcome.

15. A gaming system for playing a wagering game, comprising:
a display for displaying at least one randomly-selected outcome of a plurality of outcomes in response to accepting wager inputs from a player; and
a controller coupled to said display and programmed to
identify a gaming record based on said randomly-selected outcome during a first gaming session of said wagering game,
store a data set representing said gaming record, and
during a second gaming session of said wagering game, display said gaming record as defined by said data set.

16. The gaming system of claim 15, further comprising a gaming terminal, said display being located within said gaming terminal, said display further including at least one of a main display, a secondary display, and a standalone display.

17. The gaming system of claim 15, wherein said controller is further programmed to store said data set on at least one of a player ticket, a player card, and a memory device.

18. The gaming system of claim 15, further comprising a gaming terminal, said display and said controller being located in said gaming terminal.

19. The gaming system of claim 15, further comprising a gaming terminal, said display being located in said gaming terminal, said controller being located outside said gaming terminal.

20. A method for conducting a wagering game, comprising:
receiving wager inputs from a player for a wagering game, said wagering game being played by said player during a gaming session;
selecting at least one randomly-selected outcome of a plurality of outcomes in response to said receiving step, said plurality of outcomes including a record-making outcome;
in response to achieving said record-making outcome, saving a data set representing said record-making outcome before discontinuing said gaming session;
accessing said data set in a subsequent gaming session; and
changing said data set to represent a new record-making outcome triggered during said subsequent gaming session.
